(19) United States
(12) Patent Application Publication
(10) Pub. No.: US 2016/0035381 A1
(43) Pub. Date: Feb. 4, 2016

(54) PERPENDICULAR RECORDING MEDIA HAVING HIGH-TEMPERATURE ROBUSTNESS

(71) Applicant: HGST Netherlands B.V., Amsterdam (NL)

(72) Inventors: Shun TONOOKA, Kanagawa (JP); Masayoshi SHIMIZU, Kanagawa (JP); Hiroyuki NAKAGAWA, Kanagawa (JP); Kiwamu TANAHASHI, Tokyo (JP)

(21) Appl. No.: 14/450,151

(22) Filed: Aug. 1, 2014

(51) Int. Cl. G11B 5/73; G11B 5/84; G11B 5/66

(52) U.S. Cl. CPC G11B 5/7325; G11B 5/66; G11B 5/84

(57) ABSTRACT

A perpendicular magnetic recording medium with an grain isolation layer is disclosed. In one embodiment, a perpendicular magnetic recording medium comprises a substrate, a soft non-magnetic under layer formed over the substrate, a granular layer comprising an exchange control layer and a recording layer formed over the soft non-magnetic under layer, wherein a difference between a level at 25 deg C. and a level at 85 deg C. of a slope at a coercivity of a magnetization process curve having saturation magnetization normalized at 1 is obtained when a magnetic field is applied perpendicular to said medium, is 10% or less.

### TECHNICAL FIELD

Embodiments of the present technology relate to perpendicular magnetic recording medium having high temperature robustness.

### BACKGROUND

Many perpendicular magnetic recording media supplied to the market today have a configuration in which a soft magnetic under-layer (SUL), a seed layer formed of a Ni alloy, an intermediate layer formed of Ru (Ruthenium) or an Ru alloy, a recording layer, a carbon overcoat, and a lubricant layer are laminated in this order on a nonmagnetic substrate. In some prior art examples, the recording layer has a granular layer containing an oxide and having a granular structure, and a ferromagnetic metal cap layer not containing an oxide and not having a clear granular structure.

In recent years, the medium of PMR (perpendicular magnetic recording) or SMR (shingled magnetic recording) uses ECL (Exchange Coupling Control Layer) for the recording layer. Such a medium of the performance in room temperature is very good. However, in high temperature, degradation of writeability or SNR (signal noise ratio) is a concern.

### BRIEF DESCRIPTION OF THE DRAWINGS

The accompanying drawings, which are incorporated in and form a part of this specification, illustrate embodiments of the present technology and, together with the description, serve to explain the embodiments of the present technology:

FIG. 1 shows a layer configuration of a perpendicular magnetic recording medium in accordance with embodiments of the present invention.

FIG. 2 shows a graph 200 illustrating a change in the BER at room temperature when the film thickness of the ECL was varied using a typical perpendicular magnetic recording medium in accordance with embodiments of the present invention.

FIG. 3 is a diagram showing the relationship between the film thickness of an ECL and the saturation magnetic field, and the dependency thereof on temperature in accordance with embodiments of the present invention.

FIG. 4A reveals that Δα increased with increasing temperature regardless of which ECL material was used in accordance with embodiments of the present invention.

FIG. 4B is a diagram showing how to find an indicator of the interlayer exchange interaction mediated by an ECL in accordance with embodiments of the present invention.

FIG. 5 show diagrams illustrating the relationship between the film thickness of an ECL and the BER, and α: the slope at the coercivity of a perpendicular magnetization process, in accordance with embodiments of the present invention.

FIG. 6 shows the relationship between the rate of temperature increase of the slope at the coercivity of perpendicular magnetization process, Δα and temperature in accordance with embodiments of the present invention.

FIG. 7 is a diagram showing the relationship between drive performance at high temperatures and the rate of temperature increase Δα of the slope at the coercivity of a perpendicular magnetization process in accordance with embodiments of the present invention.

FIG. 8 is a diagram showing the relationship between degradation of SER at high temperatures and the rate of temperature increase Δα of the slope at the coercivity of a perpendicular magnetization process in accordance with embodiments of the present invention.

FIG. 9 is a diagram showing the relationship between drive performance at high temperatures and the ratio (Ptc/Coc) of the Pt concentration to the Co concentration of an ECL in accordance with embodiments of the present invention.

FIGS. 10A and 10B show schematic views of a magnetic recording device in accordance with embodiments of the present invention.

The drawings referred to in this description should not be understood as being drawn to scale except if specifically noted.

### DESCRIPTION OF EMBODIMENTS

Reference will now be made in detail to the alternative embodiments of the present technology. While the technology will be described in conjunction with the alternative embodiments, it will be understood that they are not intended to limit the technology to these embodiments. On the contrary, the technology is intended to cover alternatives, modifications and equivalents, which may be included within the spirit and scope of the technology as defined by the appended claims.

Furthermore, in the following description of embodiments of the present technology, numerous specific details are set forth in order to provide a thorough understanding of the present technology. However, it should be noted that embodiments of the present technology may be practiced without these specific details. In other instances, well known methods, procedures, and components have not been described in detail as not to unnecessarily obscure embodiments of the present technology. Throughout the drawings, like components are denoted by like reference numerals, and repetitive descriptions are omitted for clarity of explanation if not necessary.

### Overview

In recent years, the medium of PMR (perpendicular magnetic recording) or SMR (shingled magnetic recording) uses ECL (Exchange Coupling Control Layer) for the recording layer. Such a medium of the performance in room temperature is very good. However, in high temperature, degradation of writeability or SNR (signal noise ratio) is concern.

A medium using an ECL in the recording layers has been found to improve performance at room temperatures, but has the problem that writability at high temperatures is degraded. As a result, the Bit Error Rate (BER) at high temperatures does not satisfy drive performance standards. The present invention provides a medium using an ECL, and a technique for minimizing degradation of performance at high temperatures

The purpose of the present invention is to suppress degradation of writeability and SNR in high temperature and to satisfy the drive condition by using the medium which having ECL in the recording layer.

One of the features of this invention is that ECL in the recording layer contains a high amount of Pt. In particular, the ratio of Pt to Co in the ECL should be more than 25% and less than 40% to realize good performance in high temperatures. The other feature is characterized by the slope@Hc(=α), which is analyzed by the M-H loop got when a magnetic field is applied to the perpendicular direction of the medium.

The difference in a between room and high temperatures (Δα) should be less than 10%. This condition is realized when the ratio of Pt to Co in ECL is more than 25% and less than 40% as described above. If the delta_slope@Hc (=Δα) is more than 10%, the vertical exchange coupling via ECL shows decoupling behavior (see the following figure) in high temperature. In such a case, writeability and SNR is drastically degraded.

The benefit of the invention is to improve the yield of HDD test. In particular, poor performance in high temperature, which is one of the concerns in recent ECL type media, is suppressed by using this invention.

Containing much Pt in the ECL itself should be the novel way in PMR media development. And also, we propose a new indicator, slope@Hc(=α) to detect decoupling effect via ECL. The invention is well characterized by this new indicator.

The benefit of the invention is to improve the yield of HDD test. In particular, poor OW in high temperature, which is one of the concerns in recent ECL type media, is suppressed by using this invention. Containing much Pt in ECL itself should be the novel way in PMR media development. And also, we propose a new indicator, slope@Hc(=α) to detect decoupling effect via ECL. The invention is well characterized by this new indicator.

### Overview Description of Embodiments of the Present Technology Perpendicular Recording Medium with High Temperature Robustness

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Overview of Structure

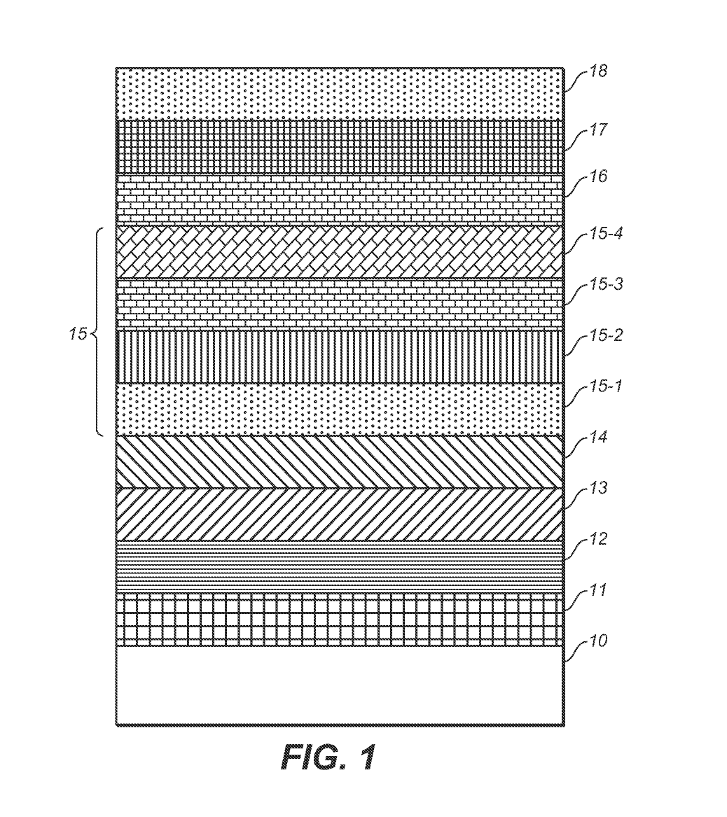

FIG. 1 shows a layer configuration of a typical perpendicular magnetic recording medium of the present invention. The perpendicular magnetic recording medium has an adhesion layer 11, a soft magnetic underlayer (SUL) 12, a seed layer 13, and an intermediate layer 14 formed successively on a substrate 10. A granular layer 15 and a ferromagnetic metal layer 16 are successively formed as recording layers on top of this, and a carbon overcoat 17 and a liquid lubricant layer 18 are successively formed on top of this.

Among these layers, the granular layer 15 has a three-layer configuration, and has an ECL. The granular layers comprise a first granular layer 15-1, a second granular layer 15-2, and a third granular layer 15-4 successively formed in this order starting from the layer closest to the substrate. An ECL 15-3 is formed between the second and third granular layers. The granular layer and the ECL are formed of a material containing an oxide in a CoCrPt alloy or a CoCrPtRu alloy.

Since the ECL must effectively lower the interlayer exchange interaction between the third and second granular layers, the ECL must have sufficiently low saturation magnetization (Ms). Although the oxide content of the ECL depends on the Ms of the second and third granular layers, making the Cr concentration of the ECL about 30 at % or greater can effectively lower the interlayer exchange interaction to achieve the role of an ECL.

In one embodiment, the perpendicular magnetic recording medium has a 15 nm of Ni-37.5Ta laminated on substrate 10 as the adhesion layer 11. Thirty nanometers of 54Co-26Co-13Ta-7Zr were laminated on top of this as an SUL 12. The SUL has an anti-ferromagnetic coupling structure (AFC structure), in which 0.4 nm of Ru was laminated on 15 nm of an underlayer SUL, then 15 nm of an over layer SUL were laminated on top of this.

Five nanometers of Ni-6W were laminated on top of the SUL as a seed layer 13. Fifteen nanometers of Ru were laminated on top of the seed layer as an intermediate layer 14. A granular recording layer 15 and a ferromagnetic metal layer 16 were successively formed on top of the intermediate layer, and a carbon overcoat 17 and a liquid lubricant layer 18 were successively formed on top of this.

Of these layers, the granular layer 15 has a three-layer configuration, in which a first granular layer 15-1, a second granular layer 15-2, and a third granular layer 15-4 were successively formed in this order from the substrate side.

An exchange coupling control layer (ECL) 15-3 was formed between the second and third granular layers, and played the role of regulating interlayer exchange interaction between the second and third granular layers. The first granular layer was formed to a film thickness of 4.5 nm using [Co-22Pt-8Cr]-4SiO2-4TiO2-1.5Oo3O4. The second granular layer was formed to a film thickness of 2.5 nm using [Co-18Pt-24Cr]-4SiO2-2.5Co3O4.

The third granular layer was formed to a film thickness of 4 nm using [Co-10.5Pt-20Cr]-4SiO2-1Co3O4. The ferromagnetic metal layer was formed to a film thickness of 3.5 nm using Co-15Pt-14Cr-8B. On top of this were formed 2.7 nm of diamond-like carbon (DLC) as a carbon overcoat, and 1 nm of a lubricant in which a perfluoroalkylpolyether-based material was diluted with a fluorocarbon material.

Although a medium configuration in which a granular recording layer has a three-layer configuration and contains an ECL in one layer was shown as a typical example of the present invention, the principles of the present invention can be applied so long as a medium is a medium in which the granular recording layer is two or more layers and contains one or more an ECL layers.

The ECL layer has the function of regulating interlayer exchange interaction between the third and second granular layers. A thicker film thickness of the ECL reduces the interlayer exchange interaction, and a thinner film thickness of the ECL increases the interlayer exchange interaction.

Reducing the interlayer exchange interaction reverses the magnetic moment of the third granular layer and incoherently reverses the magnetic moment of the second granular layer, thus improving writability. Reducing interlayer exchange interaction too much, however, causes the magnetic moment of the second granular layer and the magnetic moment of the third granular layer to reverse independently.

During this process, the magnetic moment of the second granular layer and the magnetic moment of the third granular layer do not interact, and the magnetic moments of the layers become decoupled. Decoupling the interlayer exchange interaction weakens the magnetic rotation torque generated by the magnetic moment of the third granular layer during rotation, making it difficult for the second granular layer to rotate.

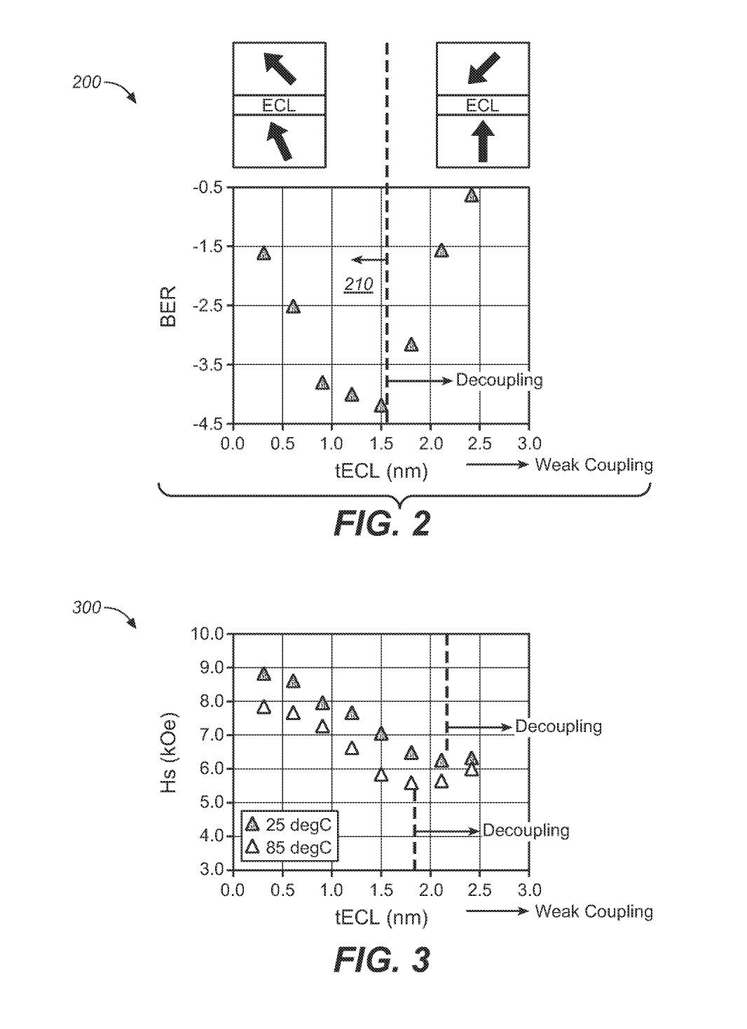

As a result, writability is degraded and the BER is greatly degraded. To understand the effect of the interlayer exchange interaction on read-write performance and the temperature dependency thereof, the present inventors carried out several principle experiments as shown in FIGS. 2 and 3.

FIG. 2 shows a graph 200 showing a change in the BER at room temperature when the film thickness of the ECL was varied using a typical perpendicular magnetic recording medium of the present invention. The BER was measured using a spin stand. A thicker film thickness of the ECL temporarily improved, then degraded the BER.

In the region 210 of FIG. 2, the BER is improved and is associated with increasing the film thickness of the ECL, incoherent rotation is promoted because interlayer exchange interaction mediated by the ECL is lowered, and as a result, writability is improved and the BER is improved. If the interlayer exchange interaction is weakened too much by too thick a film thickness of the ECL, however, the interlayer exchange interaction is decoupled, and as a result, writability is degraded and the BER is degraded.

Decoupling the interlayer exchange interaction can be detected using other indicators. FIG. 3 is a diagram 300 in which change in the film thickness of the ECL is plotted against the saturation magnetic field (Hs) obtained when a magnetic field was applied perpendicular to the medium for the perpendicular magnetic recording medium used in FIG. 2.

Change at room temperature (25 deg C.) and change at a high temperature (85 deg C.) were plotted simultaneously. Hs was measured using a polar Kerr apparatus. At either temperature, making the ECL thicker temporarily decreased, then increased Hs. Hs was reduced associated with increasing the film thickness of the ECL because lowering the interlayer exchange interaction mediated by the ECL promoted incoherent rotation. Hs was increased associated with increasing the film thickness of the ECL because thickening the ECL too much overly weakened the interlayer exchange interaction and caused it to decouple, resulting in increased Hs.

Although the film thickness of the ECL when the interlayer exchange interaction decoupled differed from FIG. 2, this was because the sweep rate and the field angle of the head magnetic field in the spin stand differed from the sweep rate and the field angle of the application magnetic field in the polar Kerr apparatus.

This difference, however, has no effect on the following discussion. FIG. 3 also indicates that the film thickness of the ECL when the interlayer exchange interaction decoupled at room temperature differed from the film thickness of the ECL when the interlayer exchange interaction decoupled at a high temperature.

This can be understood to be because the saturation magnetization (Ms) of the ECL was reduced associated with increased temperature. Reducing the Ms of the ECL weakens the interlayer exchange interaction, and as a result, shifts the film thickness of the ECL when decoupled to a thinner film thickness. That is, decoupling the interlayer exchange interaction mediated by the ECL may be said to occur more easily at high temperatures.

Thus, the following problem becomes a concern. In the case that the film thickness of the ECL at room temperature has been set so as to optimize the BER, the interlayer exchange interaction may decouple at high temperatures and greatly degrade the BER. Therefore, decoupling the interlayer exchange interaction at high temperatures must be minimized to minimize degradation of the BER at high temperatures and guarantee drive performance at high temperatures.

Detailed study by the present inventors revealed that drive performance at high temperatures can be guaranteed to the extent that Δα, defined as follows, is 10% or less with the following formula (1).

Δα={α_{IIT}−α_{RT}}/α_{RT} (1)

Where αRT and αHT are quantities. αRT represents the slope at the coercivity of a magnetization process measured when a magnetic field was applied perpendicular to the medium at room temperature (25 deg C.).

αHT represents the slope at the coercivity measured when a magnetic field was applied perpendicular to the medium at a high temperature (85 deg C.).

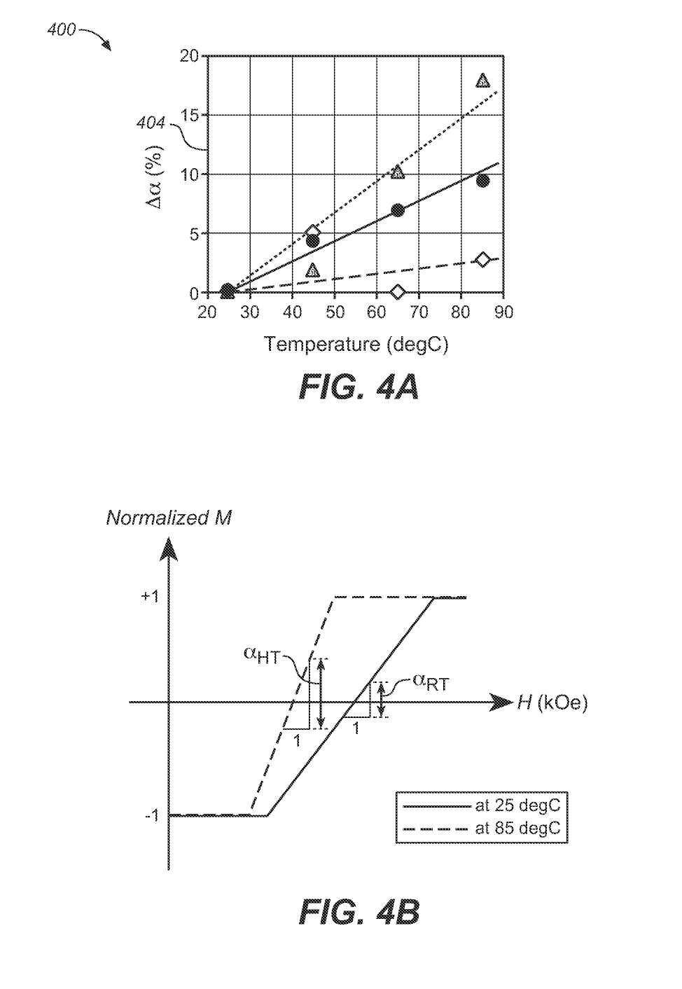

The temperature dependency of a of several ECL materials was measured for a perpendicular magnetic recording medium in which the film thickness of the ECL was set to the optimum level at room temperature. FIG. 4A shows a graph 400 representing the results. The vertical axis 404 of FIG. 4A is defined by the difference between α at 25 deg C. and α at 85 deg. C. (Δα).

FIG. 4A reveals that Δα increased with increasing temperature regardless of which ECL material was used. This is because the interlayer exchange interaction was weakened due to the Ms of the ECL falling as the temperature increased.

The amount of increase in a accompanied with temperature increase differed depending on the ECL material, and increasing the Pt concentration minimized the amount of increase in α. This was apparently because increasing the Pt concentration of the ECL material increased the magnetic anisotropy of the ECL, and as a result, minimized thermal agitation of the magnetic moment of the ECL.

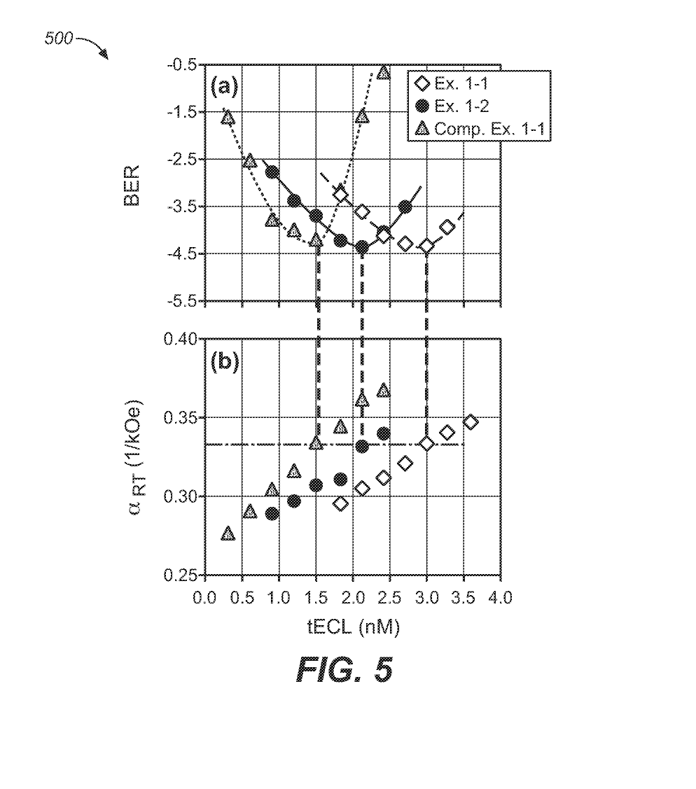

Table 1 shows the ECL material used in the present example. The film thickness of the ECL was varied in a range of 0.3 nm to 3.6 nm. The materials, film thicknesses, and sputtering conditions were the same for the layers other than the ECL. FIG. 5 shows change in the BER and change in α_{RT} when the film thickness of the ECL was varied. α_{RT} represents the slope at the coercivity of a perpendicular magnetization process at room temperature (25 deg C.), and is found by the method shown in FIG. 4B.

Table 1 shows the results of a high-temperature drive test carried out for perpendicular magnetic recording media using different ECL materials.

TABLE 1

| | | HDD drive |
|---|---|---|
| | ECL Alloy composition (mol %) | test at HT |
| Ex. 1-1 | (Co—30Cr—18.5Pt)—6SiO₂—2.5Co₃O₄ | Acceptable |
| Ex. 1-2 | (Co—30Cr—13.5Pt—5Ru)—6SiO₂—2.5Co₃O₄ | Acceptable |
| Comp | (Co—30Cr—8.5Pt—10Ru)—6SiO₂—2.5Co₃O₄ | Not |
| Ex. 1-1 | | acceptable |

As indicated in the table, the media did not pass the high-temperature drive test when the amount of increase in α was greater than 10%. Thus, the amount of increase in α must be 10% or less to satisfy drive performance at high temperatures, and the Pt concentration of the ECL material must be increased to accomplish this.

In another embodiment, the perpendicular magnetic recording medium used in the present example has the same configuration as the above described example, except for the ECL.

FIG. 5 reveal that for all ECL materials, when the interlayer exchange interaction was weakened by thickening the ECL, the BER was temporarily improved, then degraded. The reason is explained as follows. In the region in which the BER is improved associated with increasing the film thickness of the ECL, incoherent rotation is promoted because interlayer exchange interaction mediated by the ECL is lowered, and as a result, writability is improved and the BER is improved.

If the interlayer exchange interaction is weakened too much by too thick a film thickness of the ECL, however, the interlayer exchange interaction is decoupled, and as a result, writability is degraded and the BER is degraded.

Graphs (a) and (b) of FIG. 5 show that the minimum level of the BER at room temperature was nearly the same regardless of which ECL material was used. Therefore, performance at room temperature did not vary regardless of which ECL material is used. When the film thickness of the ECL was thicker, however, the film thickness at which decoupling starts differed for each ECL material.

This is because the saturation magnetization moment (Ms) of each ECL material differed, and decoupling started at a thinner film thickness for materials that have a smaller Ms. Since ECL materials with greater Ms have a stronger interlayer exchange interaction at the same film thickness, the film thickness at which decoupling started was thicker.

In one embodiment, the αRT at the ECL film thickness at which decoupling started was the same level for all ECL materials. That is, αRT is an essential indicator when discussing decoupling the interlayer exchange interaction mediated by the ECL. Media which have too high a level of αRT can be said to have greatly degraded BER because the interlayer exchange interaction is decoupled mediated by the ECL.

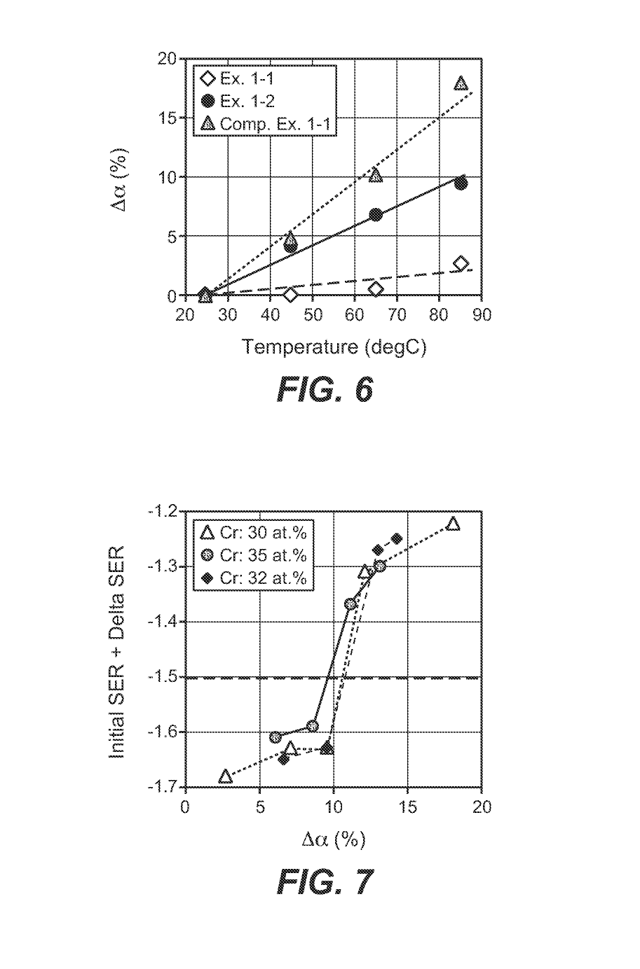

The temperature dependency of α of each ECL material was measured for a perpendicular magnetic recording medium in which the film thickness of the ECL was set to the optimum level at room temperature. FIG. 6 shows the results.

Table 2 shows the ECL materials used in the present example and the film thicknesses thereof.

TABLE 2

| | | Opt. ECL | | |
|---|---|---|---|---|
| | | thickness | Pt_{c}/Co_{c} | Δα |
| | ECL Alloy composition (mol %) | (nm) | (%) | (%) |
| Comp. | (Co—30Cr—22.5Pt)—6SiO₂—2.5Co₃O₄ | 2.3 nm | 47 | 12 |
| Ex. 2-1 | | | | |
| Ex. 2-1 | (Co—30Cr—20Pt)—6SiO₂—2.5Co₃O₄ | 2.9 nm | 40 | 7 |
| Ex. 1-1 | (Co—30Cr—18Pt)—6SiO₂—2.5Co₃O₄ | 3.0 nm | 35 | 2.7 |
| Ex. 1-2 | (Co—30Cr—13.5Pt—5Ru)—6SiO₂—2.5Co₃O₄ | 2.1 nm | 26 | 9.4 |
| Comp. | (Co—30Cr—8.5Pt—10Ru)—6SiO₂—2.5Co₃O₄ | 1.5 nm | 17 | 18 |
| Ex. 1-1 | | | | |
| Comp. | (Co—35Cr—21Pt)—6SiO₂—2.5Co₃O₄ | 1.3 nm | 48 | 11 |
| Ex. 2-2 | | | | |
| Ex. 2-2 | (Co—35Cr—18.5Pt)—6SiO₂—2.5Co₃O₄ | 1.4 nm | 40 | 6 |
| Ex. 2-3 | (Co—35Cr—13.5Pt)—6SiO₂—2.5Co₃O₄ | 1.6 nm | 26 | 8.5 |
| Comp. | (Co—35Cr—8.5Pt)—6SiO₂—2.5Co₃O₄ | 1.8 nm | 15 | 13 |
| Ex. 2-3 | | | | |
| Comp. | (Co—32Cr—20Pt—5Ru)—6SiO₂—2.5Co₃O₄ | 0.7 nm | 47 | 14.2 |
| Ex. 2-4 | | | | |
| Ex. 2-4 | (Co—32Cr—18Pt—5Ru)—6SiO₂—2.5Co₃O₄ | 0.8 nm | 40 | 6.5 |
| Ex. 2-5 | (Co—32Cr—13Pt—5Ru)—6SiO₂—2.5Co₃O₄ | 0.9 nm | 26 | 9.4 |
| Comp. | (Co—32Cr—8Pt—5Ru)—6SiO₂—2.5Co3O₄ | 1.1 nm | 15 | 12.8 |
| Ex. 2-5 | | | | |

The film thickness of each ECL was set at the optimum level of the BER measured at room temperature (25 deg C.) using a spin stand. ECL materials were prepared by varying the Co concentration and the Pt concentration when the Cr concentration was 30 at %, varying the Co concentration and the Pt concentration when the Cr concentration was 35 at %, and varying the Co concentration and the Pt concentration when the Cr concentration was 32 at %.

FIG. 7 shows Δα defined by formula (1) and results for SER in the high-temperature drive test for each series of Cr concentrations. Initial SER on the vertical axis of the graph indicates SER at room temperature (25 deg C.), and delta SER indicates how much SER degraded at high temperatures from SER at room temperature.

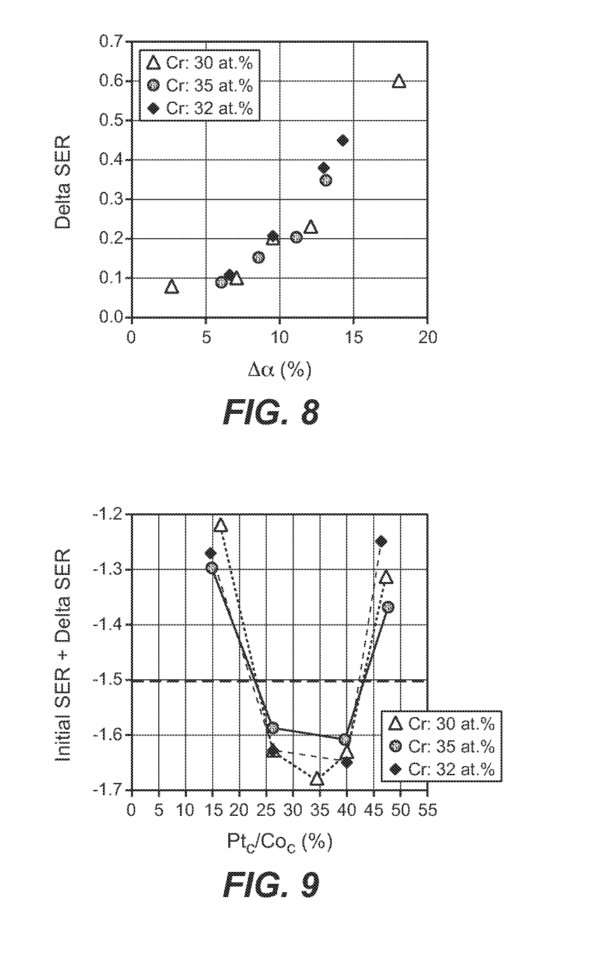

That is, initial SER+delta SER indicates SER at high temperatures. Because a drive suffers a hard stop when SER is greater than −1.5, initial SER+delta SER must be −1.5 or less to satisfy drive performance at high temperatures. FIG. 7 reveals that for all ECL materials, when Δα was 10% or less, initial SER+delta SER was −1.5 or less and satisfied drive performance at high temperatures, but when Δα was 10% or greater, initial SER+delta SER was −1.5 or greater and did not satisfy drive performance at high temperatures. This is because, as shown in FIG. 8, as Δα increased, delta SER increased because the interlayer exchange interaction mediated by the ECL decoupled at high temperatures. Thus, Δα must be 10% or less to satisfy drive performance at high temperatures.

FIG. 9 shows the relationship between the ratio (Ptc/Coc) of Pt concentration to Co concentration for the ECL materials shown in Table 2 and SER in the high-temperature drive test. This reveals that when Ptc/Coc was 25% to 40%, initial SER+delta SER was −1.5 or less, and satisfied high-temperature drive performance. As shown in Table 2, when Ptc/Coc was less than 25%, Δα was 10% or greater, and delta SER therefore increased. As a result, high-temperature drive performance was not satisfied.

Similarly, when Ptc/Coc was greater than 40%, Δα was 10% or greater, and SER therefore increased. As a result, high-temperature drive performance was not satisfied. The reason why Δα is 10% or greater when Ptc/Coc is less than 25% or greater than 40% is apparently because the magnetic anisotropy of the ECL drops in this compositional range. When the magnetic anisotropy of the ECL drops, the magnetic moment of the ECL is prone to thermal agitation. This raises the rate of decrease in Ms to increase in temperature.

As a result, the interlayer exchange interaction mediated by the ECL is overly weakened at high temperatures, and decouples. Thus, Ptc/Coc must be 25% to 40% to restrict Δα to 10% or less and satisfy drive performance at high temperatures.

The perpendicular magnetic recording medium used in the present example has the same configuration as described above, except for the ECL. Several materials were prepared varying the type of oxide in the ECL.

Table 3 shows the ECL materials used in the present example. The film thickness of each ECL was set to the optimum level of the BER measured at room temperature (25 deg C.) using a spin stand.

TABLE 3

| | | Opt. ECL | Pt_{c}/Co_{c} | Δα | Initial | delta | Initial SER + |
|---|---|---|---|---|---|---|---|
| | ECL Alloy composition (mol %) | thickness (nm) | (%) | (%) | SER | SER | delta SER |
| Ex. 2-4 | (Co—32Cr—18Pt—5Ru)—6SiO₂—2.5Co₃O₄ | 0.8 nm | 40 | 6.5 | −1.76 | 0.11 | −1.65 |
| Ex. 3-1 | (Co—32Cr—18Pt—5Ru)—6TiO₂—2.5Co₃O₄ | 0.7 nm | 40 | 6.6 | −1.77 | 0.13 | −1.64 |
| Ex. 3-2 | (Co—32Cr—18Pt—5Ru)—3TiO₂—3SiO₂—2.5Co₃O₄ | 0.8 nm | 40 | 6.5 | −1.75 | 0.12 | −1.63 |
| Ex. 3-3 | (Co—32Cr—18Pt—5Ru)—2B₂O₃—4SiO₂—2.5Co₃O₄ | 0.6 nm | 40 | 6.4 | −1.76 | 0.09 | −1.67 |
| Ex. 3-4 | (Co—32Cr—18Pt—5Ru)—2WO₃—4SiO₂—2.5Co₃O₄ | 0.6 nm | 40 | 6.6 | −1.74 | 0.12 | −1.62 |

Even if the type of oxide was varied, when Ptc/Coc was 25% to 40%, the good characteristics were obtained that Δα was restricted 10% or less, and SER in the high-temperature drive test was −1.5 or less.

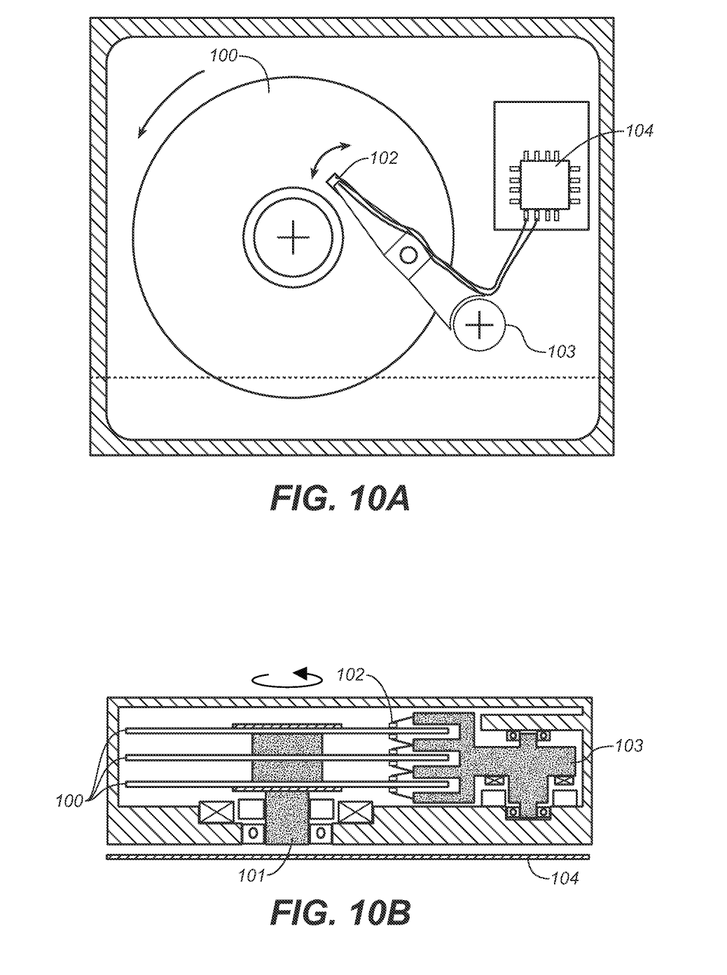

FIGS. 10A and 10B show schematic views of a magnetic recording device which is an example of the present invention. A magnetic recording medium 100 comprises a medium of the examples described earlier, and the magnetic recording device comprises a drive unit 101 for driving the device, a magnetic head 102 comprising a recording unit and a reading unit, means 103 for moving the magnetic head relative to the magnetic recording medium, and means 104 for inputting and outputting signals to and from the magnetic head.

Using a magnetic head having a track width of 70 nm could realize a surface recording density of 750 Gb/inch2 at room temperature, which could realize a magnetic recording device capable of maintaining sufficient performance even in a high-temperature environment.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A perpendicular magnetic recording medium comprising:
a substrate;
a soft non-magnetic under layer formed over said substrate;
a granular layer comprising an exchange control layer; and
a recording layer formed over said soft non-magnetic under layer,
wherein a difference between a level at 25 deg C. and a level at 85 deg C. of a slope at a coercivity of a magnetization process curve having saturation magnetization normalized at 1 is obtained when a magnetic field is applied perpendicular to said medium, is 10% or less.

2. The perpendicular magnetic recording medium of claim 1 wherein said exchange control layer comprises an oxide in a CoCrPt alloy or a or CoCrPtRu alloy.

3. The perpendicular magnetic recording medium of claim 1 wherein said granular layer comprises at least three layers.

4. The perpendicular magnetic recording medium of claim 3 wherein said exchange control layer is located within said three layers.

5. The perpendicular magnetic recording medium of claim 3 wherein said exchange control layer comprises at least Co, Pt and Cr and the ratio of Pt to Co is more than 25% and less than 40%

6. The perpendicular magnetic recording medium of claim 3 wherein said exchange control layer comprises a Cr alloy.

7. The perpendicular magnetic recording medium according to claim 1, wherein said recording layer comprises a plurality of layers.

8. The perpendicular magnetic recording medium according to claim 1, wherein said granular layer comprises three layers and wherein said exchange control layer is disposed between a second and third layer of said granular layer.

9. The perpendicular magnetic recording medium according to claim 1, wherein a layer thickness of said exchange-coupled layer is less than 0.3 nm and more than 1.5 nm.

9. A hard disk drive comprising a perpendicular magnetic recording medium, said perpendicular magnetic recording medium comprising:
a non-magnetic substrate;
an adhesion layer formed over said substrate;
an undercoat layer formed over said adhesion layer;
a soft magnetic under layer formed over said undercoat layer; and
a recording layer formed over said intermediate layer, coupled with said grain isolation layer wherein at least one layer of exchange-coupled control layers are included in said recording layer.

10. The hard disk drive of claim 9 wherein said exchange control layer comprises an oxide in a CoCrPt alloy or a CoCrRu or CoCrPtRu alloy.

11. The hard disk drive of claim 9 wherein said recording layer comprises at least three layers.

12. The hard disk drive of claim 11 wherein said exchange control layer is located between two of said three layers.

13. The hard disk drive of Claim llwherein said exchange control layer comprises at least Co, Pt and Cr and the ratio of Pt to Co is more than 25% and less than 40%

14. The hard disk drive of claim 11 wherein said exchange control layer comprises a Cr alloy.

15. The hard disk drive of claim 9, wherein said recording layer comprises a plurality of layers.

16. The hard disk drive of claim 9, wherein said recording layer comprises three layers and wherein said exchange control layer is disposed between a second and third layer of said granular layer.

17. The hard disk drive of claim 9, wherein a layer thickness of said exchange-coupled layer is less than 0.3 nm and more than 1.5 nm.

18. A method for forming a perpendicular magnetic recording medium comprising:
providing a substrate;
providing a soft non-magnetic under layer formed over said substrate;
providing a granular layer comprising an exchange control layer; and
providing a recording layer formed over said soft non-magnetic under layer, wherein a difference between a level at 25 deg C. and a level at 85 deg C. of a slope at a coercivity of a magnetization process curve having saturation magnetization normalized at 1 is obtained when a magnetic field is applied perpendicular to said medium, is 10% or less.

19. The method of claim 18 wherein said exchange control layer comprises an oxide in a CoCrPt alloy or a CoCrRu or CoCrPtRu alloy.

20. The method of claim 18 wherein said granular layer comprises at least three layers.

21. The method of claim 20 wherein said exchange control layer is located within said three layers.

22. The method of claim 20 wherein said exchange control layer comprises at least Co, Pt and Cr and the ratio of Pt to Co is more than 25% and less than 40%

23. The method of claim 20 wherein said exchange control layer comprises a Cr alloy.

24. The method of claim 18, wherein said recording layer comprises a plurality of layers.

25. The method of claim 18, wherein said granular layer comprises three layers and wherein said exchange control layer is disposed between a second and third layer of said granular layer.

26. The method of claim 18, wherein a layer thickness of said exchange-coupled layer is less than 0.3 nm and more than 1.5 nm.
